(19) United States
(12) Patent Application Publication
(10) Pub. No.: US 2013/0048897 A1
(43) Pub. Date: Feb. 28, 2013

(54) EXCHANGEABLE VALVE PLATE ASSEMBLY FOR A MOLTEN METAL SLIDE GATE VALVE

(71) Applicant: Patrick D. King, Monee, IL (US)

(72) Inventor: Patrick D. King, Monee, IL (US)

(73) Assignee: P D K LLC, Monee, IL (US)

(21) Appl. No.: 13/222,350

(22) Filed: Aug. 31, 2011

(51) Int. Cl. F16K 3/30

(52) U.S. Cl. 251/329

(57) ABSTRACT

An exchangeable valve plate assembly is provided for use in a slide gate valve. The exchangeable valve plate assembly includes a refractory exchangeable plate that may be replaced in the assembly without removing the slide gate valve from service. The exchangeable plate includes a concave cylindrical load surface(s) that is configured to be engaged by a cylindrical bar tip of a rocker arm to distribute load across a plate sealing surface and maintain a more constant load condition as the height of the plate stack changes. The rocker arms that load the plate also has the ability to float in its lateral relationship to the a pouring orifice centerline so as to further minimize changes in load force distribution to the exchangeable plate as the thickness of the plate stack changes.

### BACKGROUND OF THE MENTION

The present invention generally relates to exchangeable valve plates for use in slide gate valves for controlling a flow of molten metal, and more specifically relates to an exchangeable valve plate assembly that distributes the sealing force across a sealing surface and minimizes the change in force distribution as the thickness of the plate stack changes.

Slide gate valves are used to control the flow of molten metal in steelmaking and other metallurgical processes. For some slide gate valves where plates are exchanged sequentially during pouring, an upstream stationary plate is used in conjunction with exchangeable downstream plates. Such valves often comprise a main frame, an upstream stationary plate, and a movable exchangeable plate. The upstream stationary plate includes an orifice that is in registry with a metallurgical vessel for conducting the flow of molten metal. The movable exchangeable plate includes a flow conducting orifice that is downstream of the upstream stationary plate and which, when aligned with the orifice of the upstream stationary plate, may provide a pouring orifice. In some processes, the slide gate valve also incorporates a stationary downstream exchangeable plate that has a flow conducting orifice that is substantially aligned with an orifice of the upstream stationary plate, and which may also be part of the pouring orifice. The rate of flow of molten metal during pouring may be dependent upon the position of a stopper upstream of the upstream stationary plate, the orifice size of the moveable exchangeable plate, and/or the misalignment of the orifice of the movable exchangeable plate with the orifice of the upstream stationary plate.

Plates of such sliding gate valves are formed from heat and erosion resistant refractory materials, such as aluminum oxide, magnesium oxide, alumina carbon, magnesia carbon, and zirconium oxide, among others. Despite the heat and erosion resistance properties of such materials, the orifice(s) of the plates of such sliding gates eventually erode, corrode, or become plugged to a point that the plate(s) is/are no longer viable. For example, in steelmaking, each plate can be subjected to temperatures of 1600° C. at the area immediately surrounding the plate's flow-conducting orifice, and exposed to corrosive chemicals such as manganese, calcium, silicon, oxygen and their compounds. The resulting degradation of the flow controlling orifice(s) necessitates the termination of the pouring operation or the exchange of the plate(s) to introduce a new orifice or pouring tube into the system.

For prior slide gate valves in which all dimensions are nominal, the rocker tip of the rocker arm may be positioned to be in contact with a load surface of a plate in the plate stack or other load plate in the valve. Yet dimensional changes can occur during operation as the temperature of the plates increase, or when replacement plates are added to the valve, such as by replacing an existing movable plate. Moreover, even if the plates are manufactured to the exact same size, they often are not the same size during the plate exchange, as the existing plate typically has a higher temperature than a pre-heated replacement plate, and thus existing plate may be dimensionally longer, wider, and thicker or thinner than the incoming plate. Yet, if the dimensional tolerance of the stack up of plates is thicker or thinner than nominal, the location that the rocker arm contacts the plate stack changes, as the line of contact between the rocker arm and the stack of plates is displaced toward or away from the center line of the pouring orifice. Such changes can significantly, and adversely, alter the force distribution at the plate sealing surface. Moreover, such an alteration in the sealing force can allow metal leakage or aspiration of the surrounding atmosphere. And attempts to overcome these challenges through the use of using a swivel tip on the rocker arm that contacts the plate stack increases the cost and maintenance requirements of the system.

### BRIEF SUMMARY OF THE INVENTION

An aspect of the invention is an exchangeable plate for use with a sliding gate valve, the sliding gate vale being used to control the flow of, or protect the stream of molten metal. The exchangeable plate assembly includes an exchangeable plate. The exchangeable plate includes an upper portion that has at least one concave cylindrical load surface.

Another aspect of the invention is a cylindrical bar tip rocker arm for a sliding gate valve that controls the flow of, or protects the stream of, molten metal. The cylindrical bar tip rocker arm has a distal end, a proximate end, and a bar slot. The proximate end has a substantially cylindrical bar tip. According to certain embodiments, the cylindrical slot includes a spherical surface that is configured for engagement with a spherical washer.

A further aspect of the present invention is an assembly for use with sliding gate valves that control the flow of molten metal. The assembly includes a rotatable bar tip rocker arm that has a distal end and a proximate end. The proximate end of the bar tip rocker arm has a substantially cylindrical bar tip. The assembly also includes an exchangeable plate that has a concave cylindrical load surface configured for engagement with the substantially cylindrical bar tip.

### BRIEF DESCRIPTION OF SEVERAL VIEWS OF THE DRAWINGS

FIG. 1 illustrates a half section view of a prior art nominal dimension three plate reciprocating valve.

FIG. 2 illustrates a half section view of a prior art nominal dimension three plate reciprocating valve, the exchangeable plate being of the angled load surface type.

FIG. 3 illustrates a half section view of the three plate reciprocating valve shown in FIG. 1 in which the plate stack is thinner than nominal.

FIG. 4 illustrates a half section view of the three plate reciprocating valve shown in FIG. 1 in which the plate stack is thicker than nominal.

FIG. 5 illustrates a half section view of a three plate reciprocating valve according to an embodiment of the present invention in which the rocker arm pivot location is tangent to the upstream quadrant of the cylindrical bar tip.

FIG. 6 illustrates a half section view of a three plate reciprocating valve according to an embodiment of the present invention in which the rotational centerline that is perpendicular to the pouring orifice centerline is 10 mm upstream of tangency with the upstream quadrant of the cylindrical bar tip.

FIG. 7 illustrates a side view of a portion of an exchangeable plate assembled as a submerged pour tube holder according to an embodiment of the present invention.

FIG. 8 illustrates a side view of an exchangeable plate assembled as a blank or imperforate plate according to an embodiment of the present invention.

FIG. 9 illustrates an upstream view of an exchangeable plate assembled as a nozzle plate according to an embodiment of the present invention.

FIG. 10 illustrates a section view taken along line 10-10 in FIG. 9 of an exchangeable plate assembled as a nozzle plate with a pre-formed insert and separate nozzle.

FIG. 11 illustrates a section view taken along line 11-11 in FIG. 9 of an exchangeable plate assembled as a nozzle plate with a monolithic insert and cast in place nozzle.

FIG. 12 illustrates a downstream view of a stud or bolt mounted cylindrical bar tip rocker arm according to an embodiment of the present invention.

FIG. 13 illustrates a longitudinal section view of the stud or bolt mounted cylindrical bar tip rocker arm taken along the line 13-13 in FIG. 12.

FIG. 14 illustrates a transverse section view taken along the line 14-14 in FIG. 12 of the stud or bolt mounted cylindrical bar tip rocker arm.

FIG. 15 illustrates a downstream view of a shaft mounted cylindrical bar tip rocker arm according to an embodiment of the present invention.

FIG. 16 illustrates a longitudinal section view taken along the line 16-16 in FIG. 15 of a shaft mounted cylindrical bar tip rocker arm with the rotational centerline perpendicular to the centerline pouring orifice tangent to the upstream quadrant of the cylindrical bar tip.

FIG. 17 illustrates a longitudinal section view taken along the line 17-17 in FIG. 15 of a shaft mounted cylindrical bar tip rocker arm with the rotational centerline that is perpendicular to the pouring orifice centerline being displaced 10 mm upstream from the tangency of the upstream quadrant of the cylindrical bar tip.

The foregoing summary, as well as the following detailed description of certain embodiments, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

The following reference characters are used in the specification and figures:

| | |
|---|---|
| 1 | Vessel shell |
| 2 | Vessel lining |
| 3 | Well nozzle |
| 4 | Mounting plate insulator |
| 5 | Mounting plate |
| 6 | Main frame |
| 7 | Load element |
| 8 | Rocker arm |
| 9 | Tip load relief |
| 10 | Pouring orifice centerline |
| 11 | Rocker bolt |
| 12 | Spherical washer |
| 13 | Seal plate |
| 14 | Drive frame |
| 15 | Upstream stationary plate |
| 16 | Moving plate |
| 17 | Downstream stationary plate |
| 18 | Exchangeable plate |
| 19 | Centerline parallel to change direction |
| 20 | Centerline perpendicular to change direction |
| 21 | Swivel rocker tip |
| 22 | Angled surface exchangeable plate |
| 23 | Angled load surface |
| 24 | Contact line |
| 25 | Non contact gap |
| 26 | Rocker arm |
| 27 | Cylindrical bar tip |
| 28 | Exchangeable plate |
| 29 | Rotational centerline that is parallel to the pouring orifice |
| | centerline |
| 30 | Rotational centerline that is perpendicular to the pouring |
| | orifice centerline |
| 31 | Load vectors |
| 32 | Concave cylindrical load surface |
| 33 | Sealing surface |
| 34 | Tube portion |
| 35 | Imperforate sealing surface |
| 36 | Pouring orifice |
| 37 | Nozzle |
| 38 | Metal frame |
| 39 | Centerline of cylindrical bar tip that is parallel to the pouring |
| | orifice centerline |
| 40 | Centerline of cylindrical bar tip that is perpendicular to the |
| | pouring orifice centerline |
| 42 | Preformed insert |
| 43 | Monolithic insert |
| 44 | Shaft mounted cylindrical bar tip rocker arm |
| 45 | Rocker shaft |
| 46 | Shaft hole |
| 47 | Center of pivot slot |
| 48 | Center of spherical radius |
| 49 | Centerline of concave cylindrical load surface that is parallel |
| | to the pouring orifice centerline |
| 50 | Centerline of concave cylindrical load surface that is |
| | perpendicular to the pouring orifice centerline |
| 51 | Spherical surface |
| 52 | Cylindrical slot |
| 53 | Centerline of bar tip |
| 54 | Well nozzle flow channel |
| 55 | Upstream stationary plate orifice |
| 56 | Moving plate orifice |
| 57 | Downstream stationary plate orifice |
| 58 | Pouring tube bore |
| 59 | Downstream surface of downstream stationary plate |
| 60 | Load surface |
| 61 | Outside edge of load surface |
| 62 | Swivel tip rocker arm |
| 63 | Load vector |
| 64 | Pivot slot |
| 65 | Mortar |
| 66 | Stud mounted cylindrical bar tip rocker arm. |
| 67 | Three plate reciprocating valve |
| 68 | Proximate end |
| 69 | Distal end |
| 73 | Seat |
| 74 | Upper portion |
| 75 | Shoulder |
| 76 | Nozzle plate |

### DETAILED DESCRIPTION OF THE INVENTION

The present invention will now be described more fully with reference to the accompanying drawings, in which several embodiments are shown. This invention may, however, be embodied in many different forms and should not be construed as limited to the embodiments set forth here. Rather, these certain embodiments are examples of the invention, which has the full scope indicated by the language of the claims. Like numbers refer to like elements throughout.

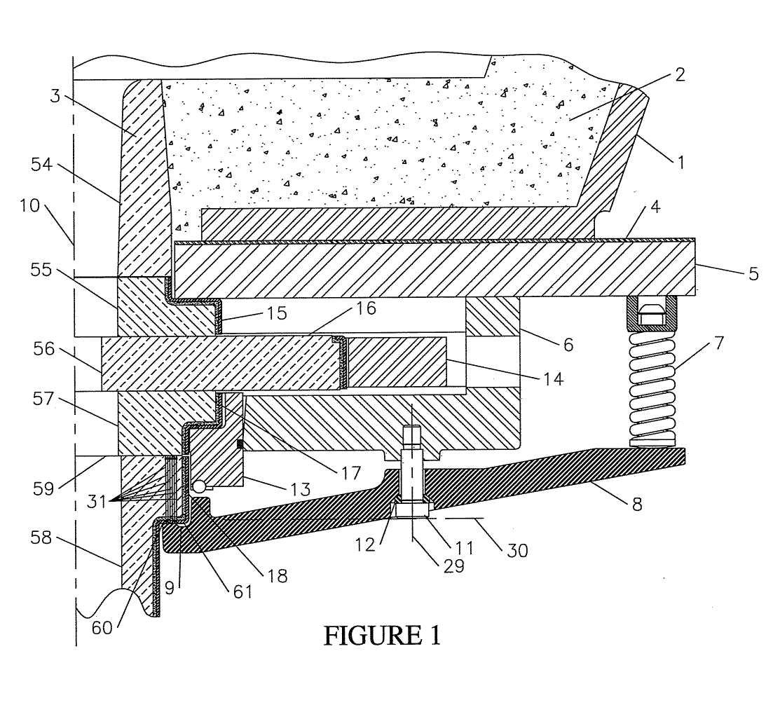

FIG. 1 illustrates a half section view of a prior art nominal dimension three plate reciprocating valve. A mounting plate 5 may be affixed to a vessel shell 1 by a mounting structure (not illustrated), such as, for example, by connecting structures that may incorporate mechanical fasteners, including, for examples bolts, screws, or pins, and/or welds, among others. A mounting plate insulator 4 may be interposed between the mounting plate 5 and the vessel shell 1.

The vessel shell 1 may be configured to contain molten metal. Further, the vessel shell 1 may include a vessel lining 2 and a well nozzle 3, the well nozzle 3 containing a well nozzle flow channel 54. The well nozzle flow channel 54 is configured to be in open communication with other pouring orifices when a moving plate orifice 56 is in an open position. More specifically, when the moving plate 16 is in an open position, pouring orifices, such as, for example, an upstream stationary plate orifice 55, a moving plate orifice 56, a downstream stationary plate orifice 57, and a pouring tube bore 58, are in open communication to provide a flow path that allows molten metal to flow from the vessel shell 1. A pouring orifice centerline 10 defines the centerline of these pouring orifices 54, 55, 56, 57.

The moving plate 16 is movable between an open position and a closed position so as to at least assist in controlling the flow of molten metal from the vessel shell 1. Moreover, the moving plate 16 is driven between the opened and closed position by a moving plate drive frame 14. More specifically, when the moving plate 16 is in the open position, molten metal is free to flow through the stationary pouring orifices 54, 55, 56, 57 at the full capacity of the system. When the moving plate 16 is in the partially closed position, as shown in FIG. 1, at least a portion of the moving plate 16 protrudes into the flow path of the molten metal and thereby reduces the flow rate of the molten metal along the molten metal flow path. When the moving plate 16 is moved to the closed position, the moving plate orifice 56 is moved out of communication with at least the upstream stationary plate orifice 55 so that the moving plate 16 blocks the flow of molten metal so that molten metal may not flow along the molten metal flow path beyond the moving plate 16.

The moving plate 16 is mechanically held firmly between the upstream stationary plate 15 and the downstream stationary plate 17. The upstream stationary plate 15 is prevented from moving upstream by its contact with the mounting plate 5. Additionally, the upstream stationary plate 15 is prevented from moving with the moving plate 16 as the moving plate 16 moves between open and closed positions, as the upstream stationary plate 15 is stroked open and closed by a separate mechanical structure (not illustrated). Further, the downstream stationary plate 17 is prevented from moving with moving plate 16 as the downstream stationary plate 17 is stroked open and closed by a seal plate 13.

The nominal dimension three plate reciprocating valve shown in FIG. 1 also includes an exchangeable plate 18 that is held in metal tight relationship with a downstream surface 59 of the downstream stationary plate 17 by a rocker arm 8. The rocker arm 8 is moveable from a loaded to an unloaded position by force that is applied to the rocker arm 8 by load element 7, the rocker arm 8 being engaged with an exchangeable plate 18 when the rocker arm 8 is the loaded position. A rocker bolt 11 provides a seat for a spherical washer 12, which allows the rocker arm 8 to rotate about the intersection of a rotational centerline 29 that is parallel to the pouring orifice centerline 10 and a rotational centerline 0 that is perpendicular to the pouring orifice centerline 10 to transfer the sealing force to exchangeable plate 18 and generate load vectors 31. The rocker arm 8 may include a tip load relief 9 configured to insure that the rocker arm 8 cannot contact the load surface 60 of the exchangeable plate 18 at the outside edge 61 of the load surface 60.

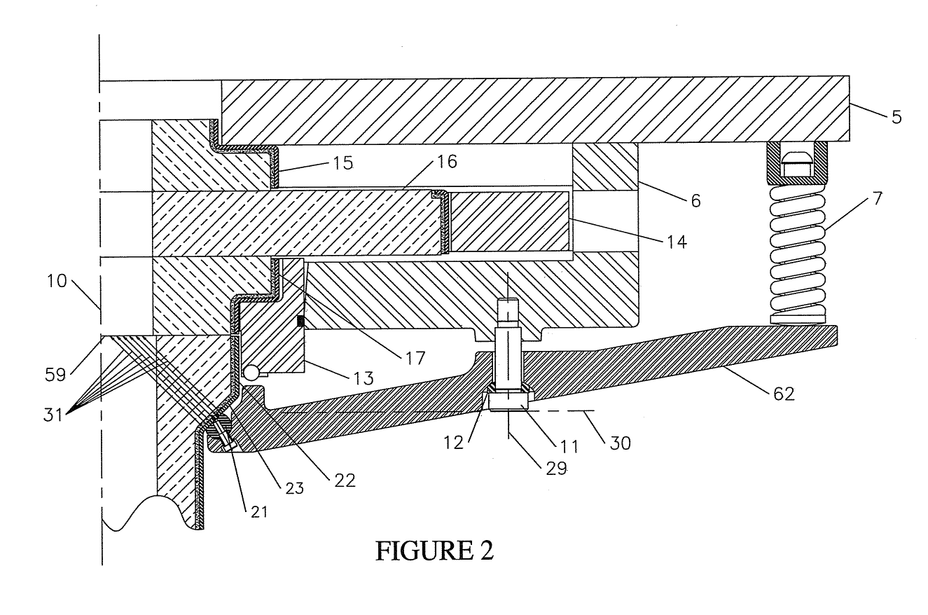

FIG. 2 illustrates a half section view of a prior art nominal dimension three plate reciprocating valve, in which the exchangeable plate 22 is of the angled load surface type and is contacted by a swivel tip 21 of a swivel tip rocker arm 62. Moreover, when a force is applied to the swivel tip rocker arm 62 by the load element 7, a sealing force is transferred through a swivel tip 21 of the swivel tip rocker arm 62 to the angled surface exchangeable plate 22 to generate load vectors 31. The sealing force provides a seal that prevents metal leakage while also preventing aspiration of the surrounding atmosphere.

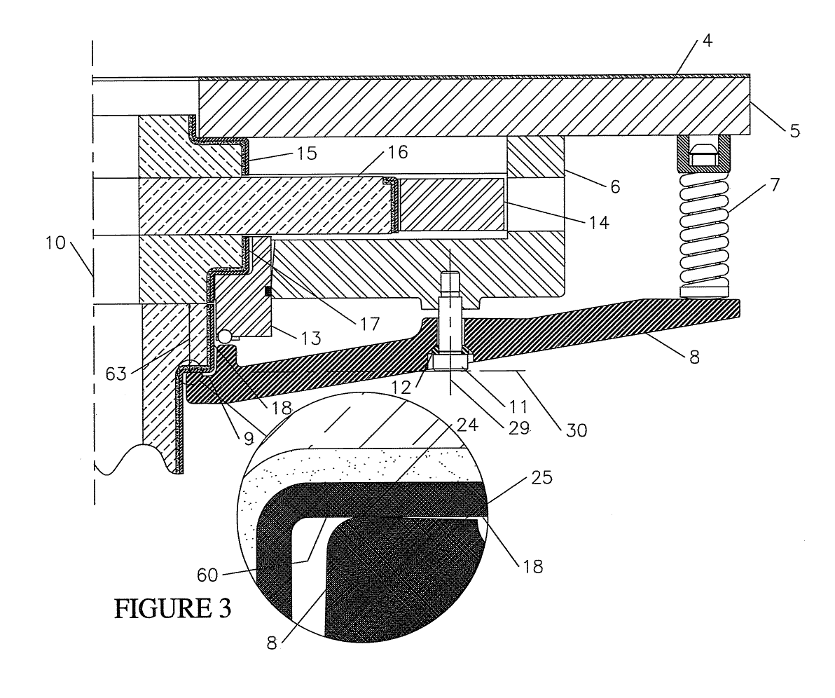

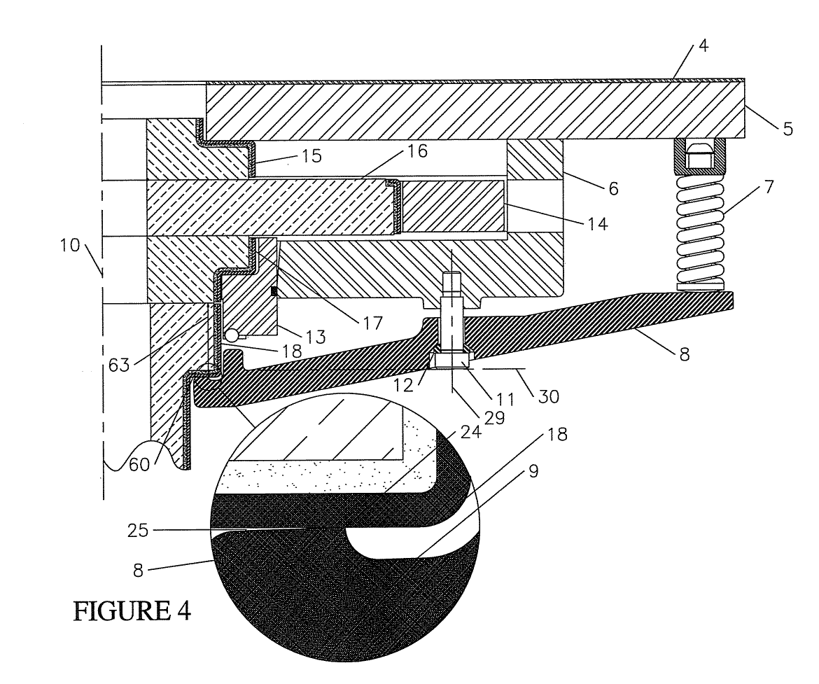

FIGS. 3 and 4 illustrate half section views of the three plate reciprocating valve shown in FIG. 1 in which the plate stack is thinner and thicker, respectively, than nominal. A change in the thickness of the stack of plates, changes the degree the rocker arm 8 rotates before coming into contact with the load surface 60 of the exchangeable plate 18. Moreover, a change in thickness, individually or collectively, of the stack of plates, such as, for example, a change in the thickness of the upstream stationary plate 15, moving plate 16, and/or downstream stationary plate 17 changes where the position the rocker arm 8 contacts the load surface 60 of the exchangeable plate 18, as well as the size of the load surface 60 that is contacted by the rocker arm 8. For example, as shown in FIG. 3, a rotated rocker arm 8 contacts the load surface 60 at contact line 24, creating non-contact gap 25, and load vector 63. In FIG. 4, the rocker arm 8 contacts the load surface 60 at contact line 24, creating non-contact gap 25, and load vector 63.

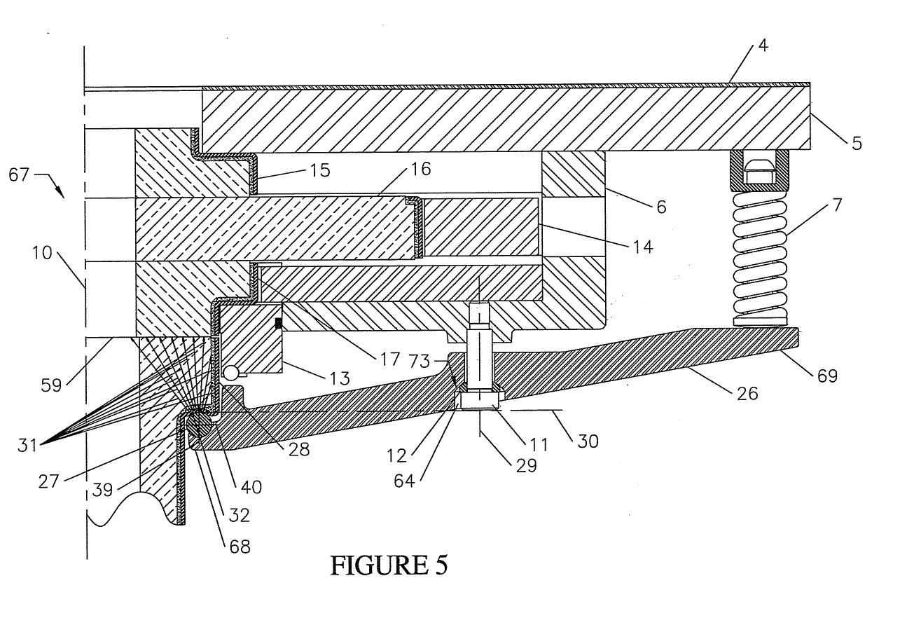

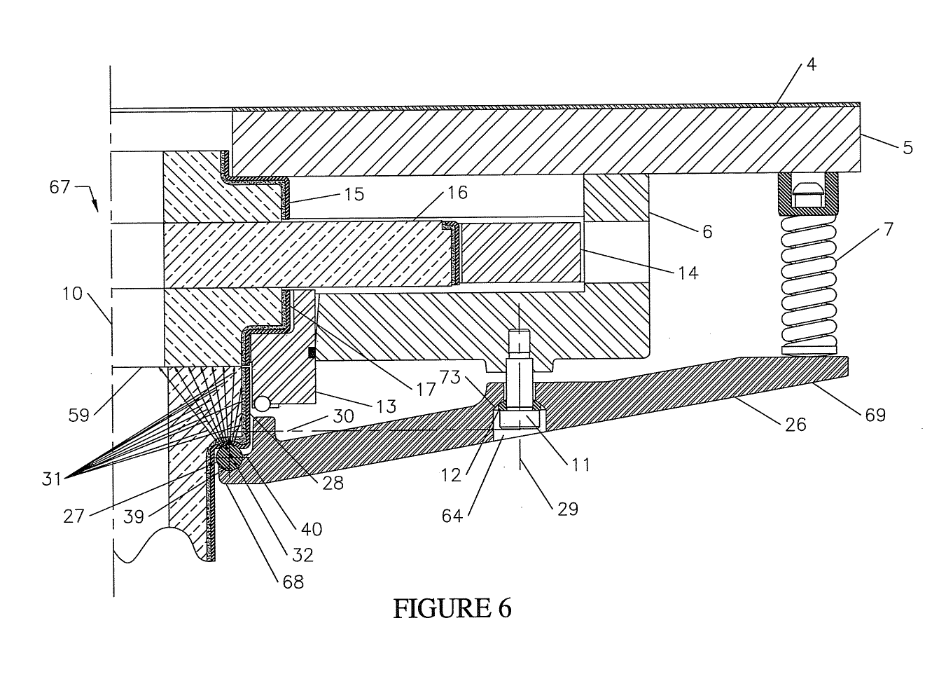

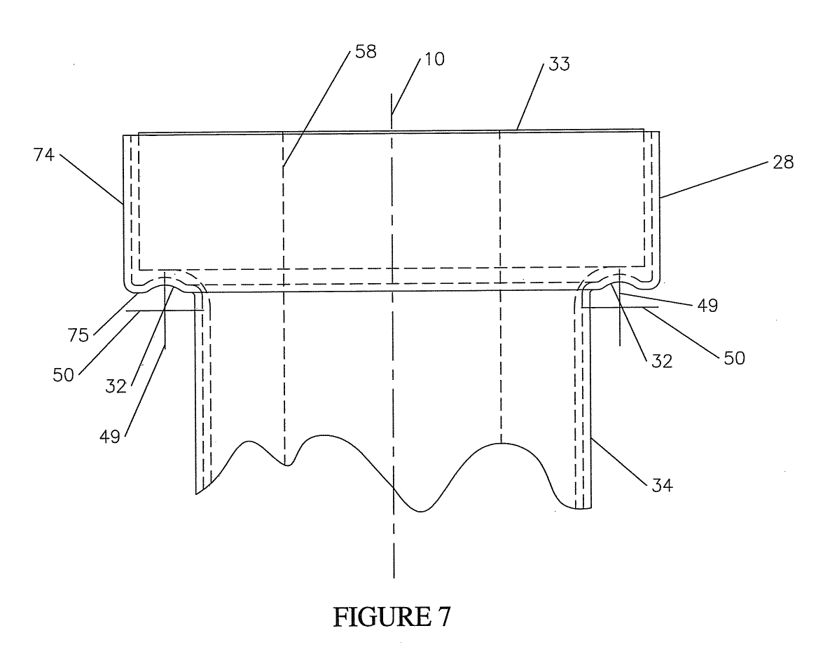

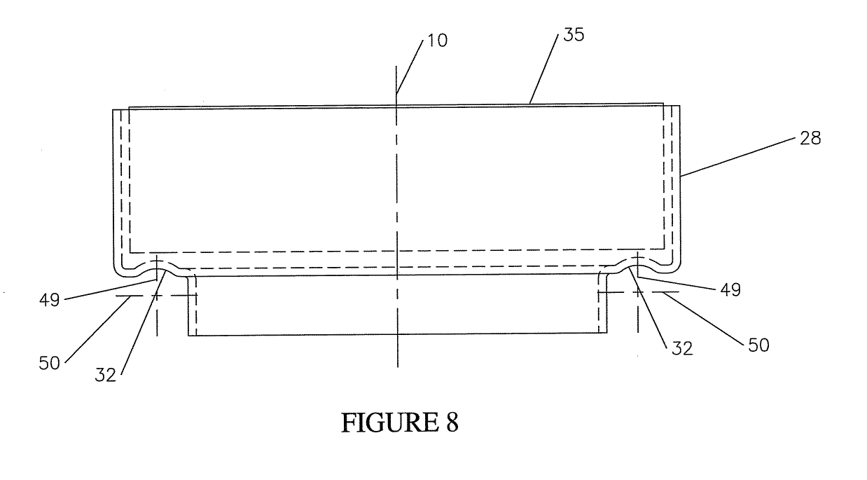

FIG. 5 illustrates a half section view of a three plate reciprocating valve assembly 67 according to an embodiment of the present invention in which a bar tip rocker arm 26 is in a loaded position. FIG. 6 illustrates a half section view of the three plate reciprocating valve 67 in which a perpendicular rotational centerline 30 is 10 mm upstream of tangency with the upstream quadrant of an at least partially cylindrical bar tip 27. As shown the bar tip rocker arm 26 includes a proximate end 68, a distal end 69, and a pivot slot 64. A cylindrical bar tip 27 is attached, such as by pin, bolt, screw, or weld, among others, or formed at or near the proximate end 68 of the bar tip rocker arm 26. The cylindrical bar tip 27 is configured to engage an exchangeable plate 28 when the bar tip rocker arm 26 is pivoted to the loaded position, as shown in FIG. 5. More specifically, as discussed below and shown in FIGS. 7 and 8, the cylindrical bar tip 27 is configured to engage a concave cylindrical load surface 32 of the exchangeable plate 28 when the bar tip rocker arm 26 is in the loaded position. The intersection of the centerline 39 (that is generally parallel to the pouring orifice centerline 10) of the cylindrical bar tip 27 and the centerline 40 (that is generally perpendicular to the pouring orifice centerline 10) of the cylindrical bar tip 27 may define the location of cylindrical bar tip 27.

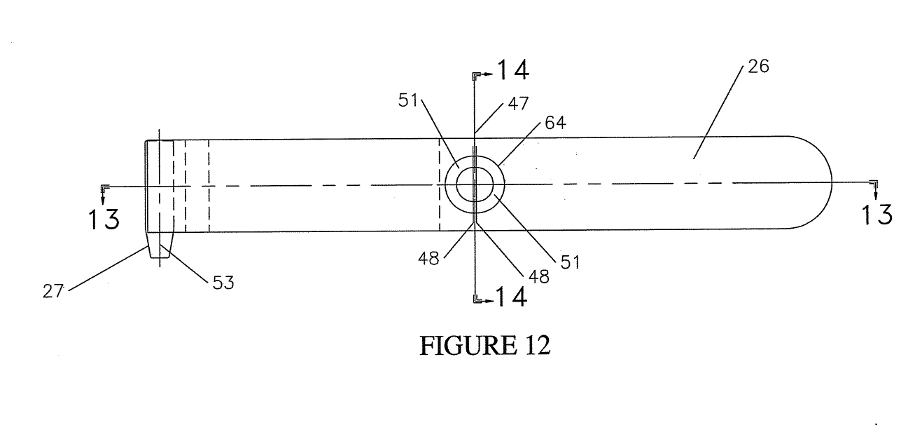

The pivot slot 64 is configured to receive a stud or rocker bolt 11, the rocker bolt 11 being mechanically secured to the three plate reciprocating valve 67, such as, for example, by a bolted, pinned, or welded connection, among others, to the main frame 6. As shown in FIG. 12, the pivot slot 64 may have a center 47 that is generally located at the theoretical center of rotation of the bar tip rocker arm 66 and define the long axis of the pivot slot 64. The pivot slot 64 allows the bar tip rocker 66 to be rotated along an arc towards and away from the pouring orifice centerline 10. Such movement allows the cylindrical bar tip 27 of the bar tip rocker arm 66 to move in a straight line parallel to the pouring orifice centerline 10 and maintain contact with the convex cylindrical load surface 32 of the exchangeable plate 28.

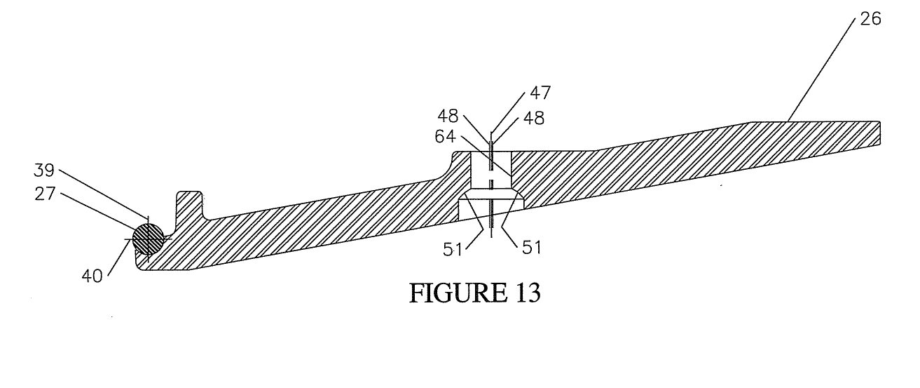

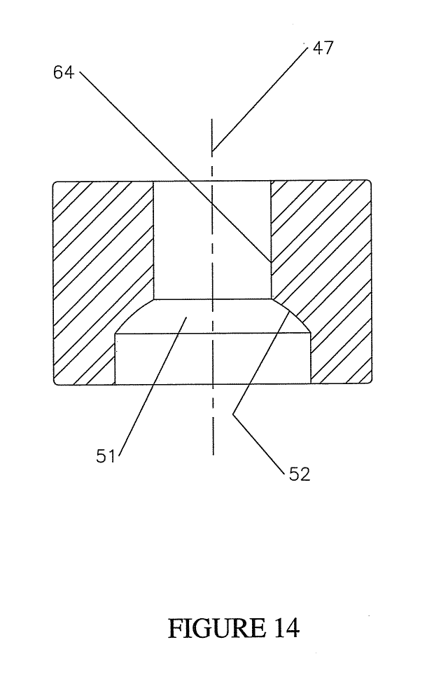

A spherical washer 12 is seated in the pivot slot 64 and/or on the rocker bolt 11, and is configured to assist with the ability of the bar tip rocker arm 26 to be rotated about the intersection of the parallel rotational centerline 29 (which is generally parallel to the pouring orifice centerline 10) and the perpendicular rotational centerline 30 (which is generally perpendicular to the pouring orifice centerline 10). As shown in FIGS. 5, 13, and 14, according to certain embodiments, the pivot slot 64 may include cylindrical slot 52 that has a seat 73 may be formed, such as, for example, through the use of a ball end cutter. The seat may be configured to receive a spherical washer 12 that allows the bar tip rocker 26 arm to float towards and away from the pouring orifice centerline 10 as the stack up in the valve changes. According to certain embodiments, the cylindrical slot 52 transitions to spherical surfaces 51 at either end of cylindrical slot 52. Additionally, the center of spherical radius 48 may define points where pivot slot 64 transitions to the spherical surfaces 51. According to certain embodiments, the spherical slot is about 0.50 mm to about 2.0 mm displaced from a centerline of a spherical radius of the spherical surface.

Besides being configured to receive the insertion of the rocker bolt 11, according to certain embodiments, the pivot slot 64 may also be sized to allow for some lateral displacement, or float, of the bar tip rocker arm 26 so that the bar tip rocker arm 26 may move toward and away from the pouring orifice centerline 10. For example, for a bolt mounted bar tip rocker arm 26, providing the pivot slot 64 with sufficient clearance for the rocker bolt 11, such as, for example, by making the pivot slot 70 1.0 to 3.0 mm larger than the rocker bolt 11 may allow the bar tip rocker arm 26 to move towards and away from the pouring orifice centerline 10. Such float may assist in maintaining proper alignment between the engagement of the cylindrical bar tip 27 and the concave cylindrical load surface 32 as the thickness of the stack of plates 15, 16, 17, and/or 28 changes.

Plates, such as, for example, a downstream stationary plate 17 and/or a moveable plate 16, are loaded by the rocker arm 26. Moreover, force is applied to the distal end 69 of the bar tip rocker arm 26 by a load element 7, which may result in the pivoting or rotational movement of the bar tip rocker arm 26 about the rocker bolt 11 to a loaded position so that the cylindrical bar tip 27 engages and/or transmits a force against the exchangeable plate 28. The cylindrical bar tip 27 is configured to complement the concave cylindrical load surface 32 of the exchangeable plate 28. According to certain embodiments, the cylindrical bar tip 27 and mating concave cylindrical load surface 32 may be sized to maximize the contact surface between the cylindrical bar tip 27 and concave cylindrical load surface 32, while still allowing operability and structural integrity of the rocker arm 26 and/or exchangeable plate 28, so as to lower unit pressure and avoid friction welding. For example, according to an embodiment, the concave cylindrical load surface 32 may have a concave cylindrical radius of about 4 mm to about 15 mm, while the cylindrical bar tip 27 may have a diameter of about 8.0 mm to about 30.0 mm

When the bar tip rocker arm 26 is moved to the loaded position, the cylindrical bar tip 27 may transmit a force against the exchangeable plate 28 that is sufficient to hold the exchangeable plate 28 in a metal tight, sealable relationship with the downstream surface 9 of the downstream stationary plate 17. The contact between the concave cylindrical load surface 32 of the exchangeable plate 28 and a cylindrical portion of the cylindrical bar tip 27 of the rocker arm 26 provides an array of force vectors 31 into the exchangeable plate 28 emanating from the center line of the cylindrical bar tip 27. This array of force vectors 31 spreads the sealing load across the sealing surface 33, 35 (shown in FIGS. 7 and 8) of the exchangeable plate 28.

The bar tip rocker arm 26 is configured to maintain intimate contact between a concave cylindrical load surface(s) 32 and a cylindrical bar tip(s) 27 such that the force distribution on the exchangeable plate 28 surface generally will not change, or not change significantly, as the thickness and/or width of the stack of plates 15, 16, 17, and/or 28 individually or collectively changes due to, for example, manufacturing specifications, tolerances, or production, or thermal expansion. As the thickness of the stack of plate 15, 16, 17, and/or 28, or plate stack, changes, the bar tip rocker arm 26 may rotate about its pivot point to accommodate those changes. For example, during operation of a three plate reciprocating valve 67, the exchangeable plates may become worn, damaged, or otherwise compromised. Therefore, replacement plates are typically placed in position to replace existing plates without interruption of the operation of the system. Moreover, when a new plate is to be inserted into the operating position, a drive mechanism, such as a motorized or electric screw, for example, may push or pull the replacement plate into the operating position, and thereby push the existing plate out of operation. However, due to a number of different factors, such as a difference in the temperatures and/or manufactured sizes of the new and replaced plate 28, among others, the thickness of the plate stack may change, thereby changing the position of the rocker arm 26 and/or the position the rocker arm 26 contacts the exchangeable plate 28. The inability of a system to accommodate for such changes may adversely impact the load vectors from the force exerted by the rocker arm 26 on the exchangeable plate 28. The present invention however accommodates for such changes in plate stack thickness. The system may be designed to place the perpendicular rotational center line 30 tangent to the upstream quadrant of the cylindrical bar tip 27. Such a configuration may minimize the change in dimension between the centerline of the cylindrical bar tip 27 and the pouring orifice centerline 10 as the thickness of the stack of plates 15, 16, 17, and/or 28 changes. Additionally, such changes in plate thickness may also be accommodated by the ability of the bar tip rocker arm 26 to float toward or away from the pouring orifice centerline 10, as previously discussed. Failure to account for such dimensional changes in the design of the bar tip rocker arm 26 typically will cause a change in force distribution at the plate sealing surface 33 that can be detrimental to the performance of the three plate reciprocating valve 67.

FIG. 7 illustrates a side view of a portion of an exchangeable plate 28 assembled as a submerged pour tube holder according to an embodiment of the present invention. According to such an embodiment, the exchangeable plate 28 includes a sealing surface 33, an upper portion 74, a tube portion 34, and one or more concave cylindrical load surfaces 32. The concave cylindrical load surface 32 may be disposed at or about at least a portion of an outer shoulder 75 of the upper portion 74. According to certain embodiments, the concave cylindrical load surface 32 is generated about the intersection of the centerline 49 of concave cylindrical load surface 32 that is parallel to the pouring orifice centerline 10 and the centerline 50 of the concave cylindrical load surface 32 that is perpendicular to the pouring orifice centerline 10. Additionally, a tube bore 58 passes through the upper and tube portions 74, 34 of the exchangeable plate 28. When assembled in the three plate reciprocating valve 67, the tube bore 58 is generally aligned along the pouring orifice centerline 10 so that molten metal flowing out of the moveable plate orifice 56 may flow through the tube bore 58 of the exchangeable plate 28.

FIG. 8 illustrates a side view of an exchangeable plate 28 that is assembled as a blank or imperforate plate according to an embodiment of the present invention. As shown, the exchangeable plate 28 may include an imperforate sealing surface 35. The imperforate sealing surface 35 may provide an exchangeable plate 28 without an orifice that is configured to shutoff the flow of molten metal in the event shutdown of the system is required, such as when a the moving plate 16 being used by the system is leaking. In the event such a shutdown is necessary, the exchangeable plate 28 with the imperforate sealing surface 35 may be fired into the system and effect a shutdown despite the leaking moving plate 16.

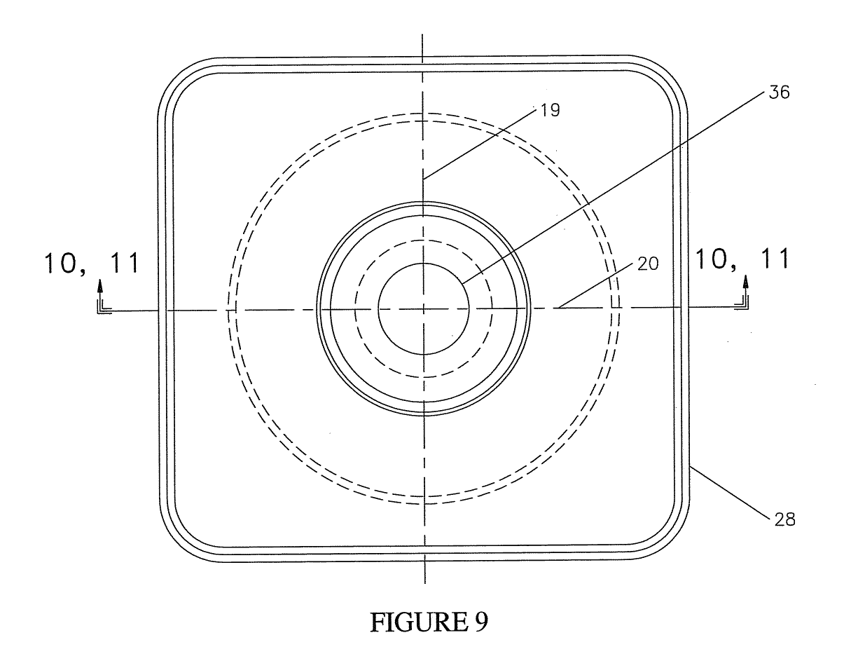

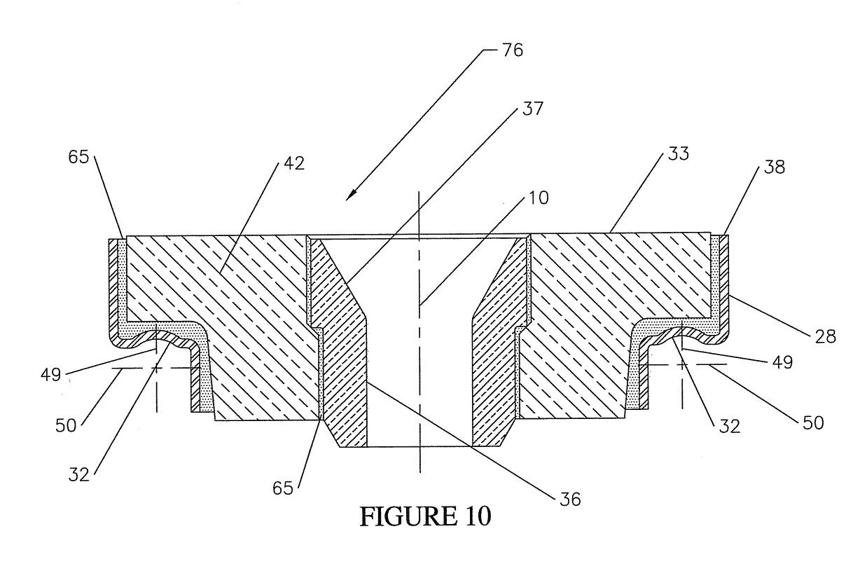

FIG. 9 illustrates an upstream view of an exchangeable plate 28 assembled as a nozzle plate 76 according to an embodiment of the present invention. FIG. 10 illustrates a section view taken along line 10-10 of FIG. 9 of an exchangeable plate assembled as a nozzle plate 76 with a pre-formed insert 42 and separate nozzle 37 according to an embodiment of the present invention. As illustrated, the intersection of the centerline 19 that is parallel to a plate change direction and the centerline 36 that is perpendicular to the change direction generally defines the center of the pouring orifice 36. According to certain embodiments, the exchangeable plate 28 may be at least partially encased by a metal frame 38. Additionally, according to certain embodiments, the nozzle 37 is mounted in a preformed insert 42 that is mounted in metal frame 38 with mortar 65. The pouring orifice centerline 10 may pass through the sealing surface 33 and be generally surrounded by a pouring orifice 36 in the nozzle 37.

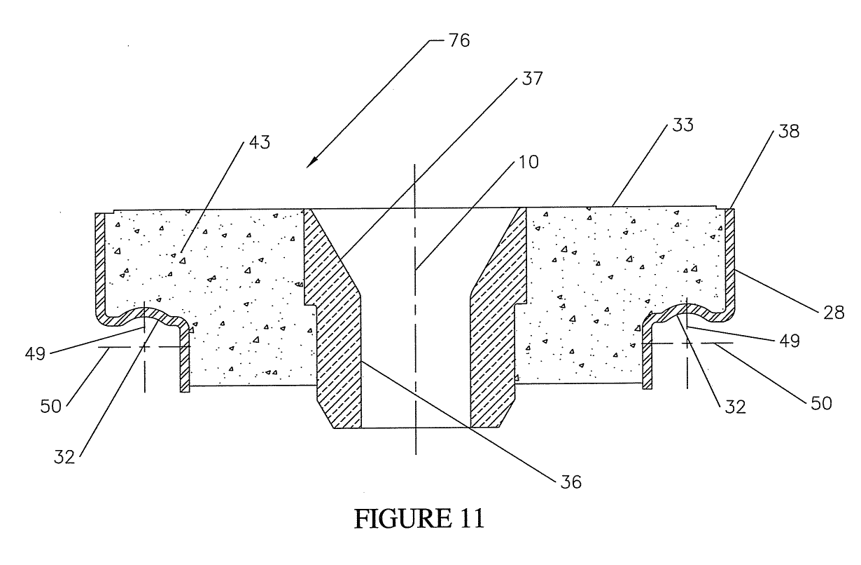

FIG. 11 illustrates a section view taken along line 11-11 of FIG. 9 of the exchangeable plate 28 assembled as a nozzle plate 76 with a monolithic insert 43 and cast in place nozzle 37 according to an embodiment of the present invention. The monolithic insert 43 may be formed in situ in the metal frame 38. The nozzle 37 may also be contained in the monolithic insert 43. When assembled in the three plate reciprocating valve 67, the pouring orifice centerline 10 generally passes through the sealing surface 33 and is at least partially surrounded by the pouring orifice 36 in nozzle 37.

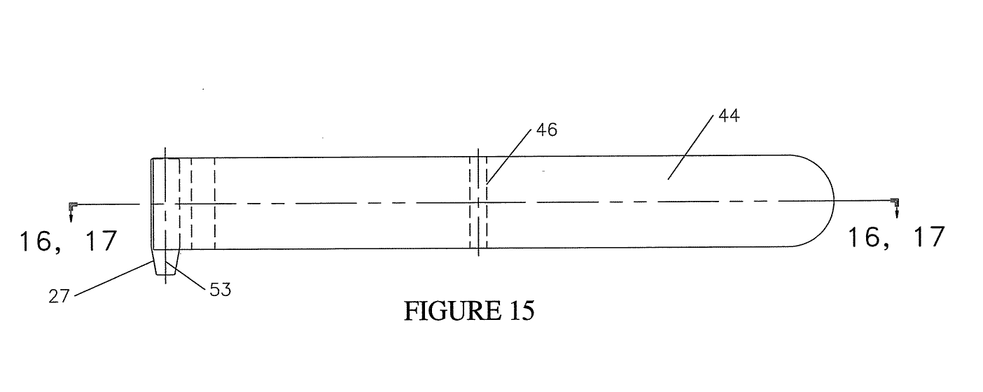

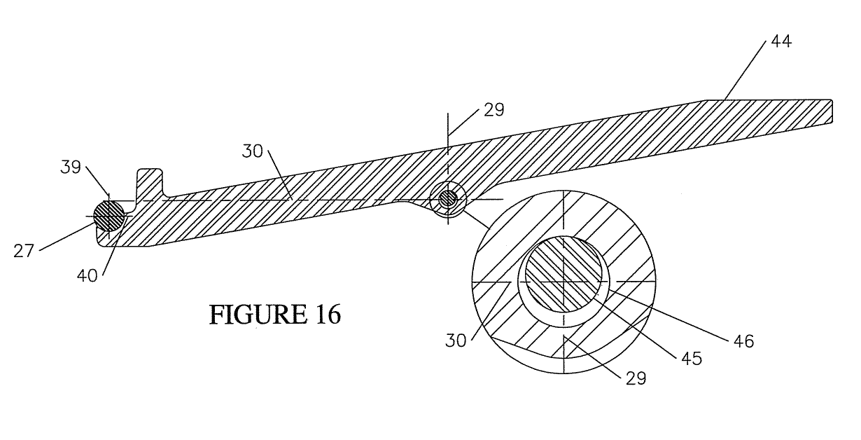

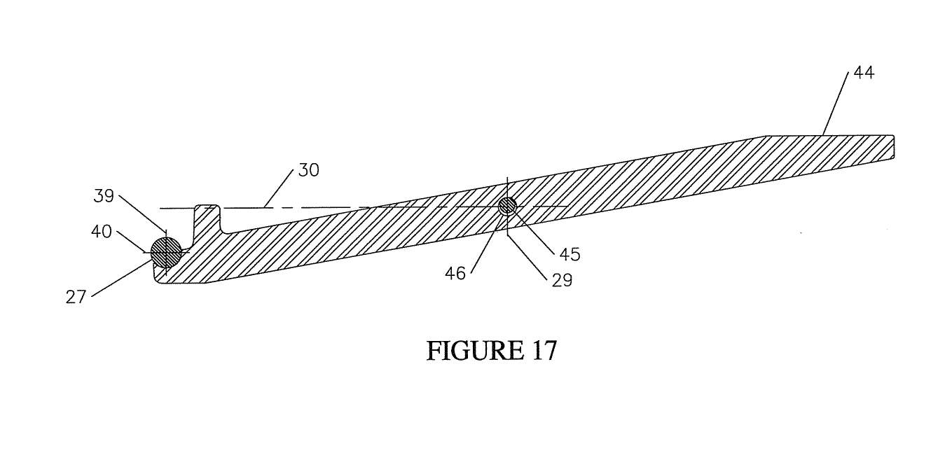

FIGS. 15-17 illustrate a shaft mounted cylindrical bar tip rocker arm 44. The bar tip rocker arm 44 includes a bar slot in the form of a shaft hole 46 and a cylindrical bar tip 27. The shaft hole 46 is located at the theoretical center of rotation of the bar tip rocker arm 44. Moreover, the intersection of the centerline 29 of the bar tip rocker arm 44 (that is parallel to the pouring orifice centerline 10) and the rotational centerline 30 (that is perpendicular to the pouring orifice centerline 10) may define the location of shaft hole 46 in bar tip rocker arm 46. Further, the rotational centerline 30 may be tangent to the upstream quadrant of cylindrical bar tip 27. According to certain embodiments, the rotational centerline 30 is 10 mm upstream of the upstream quadrant of cylindrical bar tip 27.

The rocker shaft 45 is sized for insertion into, and is tangent to the upstream quadrant of, the shaft hole 46. The shaft hole 46 may be oversized in relation to the size of the rocker shaft 45 so that the bar tip rocker arm 44 may move towards and away from the pouring orifice centerline 10 to accommodate the arc generated when the bar tip rocker arm 44 rotates. Such movement may allow the cylindrical bar tip 27 to be moved in a straight line parallel to the pouring orifice centerline 10 and maintain intimate contact with the concave cylindrical load surface 32 of the exchangeable plate 28.

In view of the foregoing, and for illustrative purposes, according to one example, a bolt or stud mounted rocker arm 26 having a rotational centerline 30 perpendicular to the pouring orifice centerline 10 tangent to the upstream quadrant of the cylindrical bar tip 27 may include a cylindrical bar tip 27 having a radius of 221.944 mm from the pivot point to the upstream quadrant of the cylindrical bar tip 27. With such a bar tip rocker arm 26, a 1.0 mm change in the thickness of the plate stack 15, 16, 17, and/or 28 may result in a change in the distance from the upstream quadrant of the cylindrical bar tip 27 to the pouring orifice centerline 10 of 0.00225 mm. Moving the upstream quadrant of the load 0.00225 mm away from the pouring orifice centerline 10 may result in a line contact between the cylindrical bar tip 27 and the concave cylindrical load surface 32, and a single force vector at 0.129° away from the pouring orifice centerline 10. Conversely moving the upstream quadrant of the cylindrical bar tip 27 0.00225 mm toward the pouring orifice centerline 10 may result in a line contact between the cylindrical bar tip 27 and the concave cylindrical load surface 32, and a single force vector at 0.129° toward the pouring orifice centerline 10. For a stud mounted rocker arm 26 with the rotational centerline 30 perpendicular to the pouring orifice centerline 10 mm upstream of the tangency with the upstream quadrant of the cylindrical bar tip 27, with a 222.17 mm radius from the centerline 30 of rotation to the upstream quadrant of the cylindrical bar tip 27, a 1.0 mm increase in the stack height of the plates may result in a change in the distance from the upstream quadrant of the cylindrical bar tip 27 to the pouring orifice centerline 10 of 0.04732 mm. This is 18.93 times the change that results from the previous example with optimum geometry.

According to another example, a shaft mounted bar tip rocker arm 44 may have a 10 mm diameter rocker shaft 45, a 12.0 mm diameter hole 46 in the bar tip rocker arm 44, and a rotational centerline 30 perpendicular to the pouring orifice centerline 10 tangent to the upstream quadrant of the cylindrical bar tip 27, with a radius of 221.944 mm from the pivot point to the upstream quadrant of the cylindrical bar tip 27. A 1.0 mm change in plate stack thickness will result in a change in the distance from the upstream quadrant of the cylindrical bar tip 27 to the pouring orifice centerline 10 of 0.00225 mm. Maintaining the centerline of the cylindrical bar tip 27 at a fixed distance from the pouring orifice centerline 10 and changing the plate stack thickness by 1.0 mm may cause the bar tip rocker arm 44 to move 0.0000033 mm upstream at the pivot due to climbing over the rocker shaft 45. Moving the upstream quadrant of the cylindrical bar tip 27 0.00225 mm away from the pouring orifice centerline 10 results in a line contact between the cylindrical bar tip 27 and the concave cylindrical load surface 32, and a single force vector of 0.129° away from the pouring orifice centerline 10. Conversely moving the upstream quadrant of the cylindrical bar tip 27 0.00225 mm toward from the pouring orifice centerline 10 results in a line contact between the cylindrical bar tip 27 and the concave cylindrical load surface 32, and a single force vector of 0.129° toward from the pouring orifice centerline 10. For a shaft mounted rocker arm 44 with the rotational centerline 30 perpendicular to the pouring orifice centerline 10 mm upstream of the tangency with the upstream quadrant of the cylindrical bar tip 27, a 10.0 mm diameter rocker shaft 45 and a 12.0 mm diameter hole 46 in the rocker arm 44, with a 222.755 mm radius from the centerline 30 of rotation to the upstream quadrant of the cylindrical bar tip 27, a 1 mm increase in the stack height of the plates will result in a change in the distance from the upstream quadrant of the load to the pouring orifice centerline 10 of 0.087789 mm. This is 35.11 times the change that results from the previous example with optimum geometry. Maintaining the centerline of the cylindrical bar tip 27 at a fixed distance from the pouring orifice centerline 10 and changing the plate stack thickness by 1.0 mm may cause the rocker arm 44 to move 0.005777 mm upstream at the pivot due to climbing over the rocker shaft 45. Moving the upstream quadrant of the cylindrical bar tip 27 0.087789 mm away from the pouring orifice centerline 10 results in a line contact between the cylindrical bar tip 27 and the concave cylindrical load surface 32, and a single force vector of 5.017° away from the pouring orifice centerline 10. Losing the intimate contact between the cylindrical bar tip 27 and the concave cylindrical load surface 32 of the plate results in the loss of the force vector array, and the formation of a single force vector that can vary from 37.5° toward the pouring orifice centerline 10 to 37.5° away from the pouring orifice centerline 10.

1. An exchangeable plate for use with a sliding gate valve that controls the flow of, or protects the stream of, molten metal, the exchangeable plate assembly comprising an exchangeable plate having an upper portion, the upper portion having at least one concave cylindrical load surface.

2. The exchangeable plate of claim 1, wherein the exchangeable plate is at least partially encased by a metal frame.

3. The exchangeable plate of claim 1, wherein the at least one concave cylindrical load surface has a concave cylindrical radius of about 4 mm to about 15 mm.

4. The exchangeable plate of claim 1, wherein the upper portion includes a downstream shoulder, the one or more concave cylindrical load surfaces being positioned on the downstream shoulder.

5. The exchangeable plate of claim 1, further including a tube portion that extends from the upper portion and further including a tube bore that extends into the upper portion and the tube portion.

6. The exchangeable plate of claim 1, wherein the exchangeable plate includes an imperforate sealing surface.

7. The exchangeable plate of claim 1, wherein the plate assembly incorporates a separate nozzle.

8. The exchangeable plate of claim 1, wherein the plate assembly incorporates a pre-formed insert mortared into a metal frame.

9. The exchangeable plate of claim 1, wherein the plate assembly incorporates a monolithic insert.

10. A cylindrical bar tip rocker arm for a sliding gate valve that controls the flow of, or protects the stream of, molten metal, the cylindrical bar tip rocker arm having a distal end, a proximate end, and a bar slot, the proximate end having a substantially cylindrical bar tip.

11. The cylindrical bar tip rocker arm of claim 10, wherein the cylindrical bar tip has a diameter of about 8.0 mm to about 25.0 mm.

12. The cylindrical bar tip rocker arm of claim 10, the bar slot including a spherical surface configured for engagement with a spherical washer.

13. The cylindrical bar tip rocker arm of claim 12, wherein the cylindrical bar tip rocker is configured to be mounted on a rocker bolt, the bar slot being 1.0 to 3.0 mm wider than the rocker bolt.

14. The cylindrical bar tip rocker arm of claim 12, wherein the spherical slot is about 0.50 mm to about 2.0 mm displaced from a centerline of a spherical radius of the spherical surface.

15. The cylindrical bar tip rocker arm of claim 10, wherein the cylindrical bar tip rocker arm is configured to be mounted on a shaft, the bar slot being a shaft hole that is approximately 1.0 to 3.0 mm larger than the shaft.

16. An assembly for use with sliding gate valves that control the flow of molten metal, the assembly comprising:
a rotatable bar tip rocker arm, the rotatable bar tip rocker arm having a distal end and a proximate end, the proximate end having a substantially cylindrical bar tip; and
an exchangeable plate having a concave cylindrical load surface configured for engagement with the substantially cylindrical bar tip.

17. The assembly of claim 16, wherein the rotatable bar tip rocker arm includes a pivot slot configured to receive the insertion of a rocker bolt and a spherical washer, the pivot slot sized to allow lateral movement of the rotatable bar tip rocker arm toward or away from a pouring orifice centerline of the exchangeable plate.

18. The exchangeable plate of claim 17, wherein the upper portion includes a downstream shoulder, the one or more concave cylindrical load surfaces being positioned on the downstream shoulder.

19. The assembly of claim 16, wherein the rotatable bar tip rocker arm includes a shaft hole configured to receive the insertion of a shaft, the shaft hole sized to allow lateral movement of the rotatable bar tip rocker arm toward or away from a pouring orifice centerline of the exchangeable plate.

20. The exchangeable plate of claim 19, wherein the upper portion includes a downstream shoulder, the one or more concave cylindrical load surfaces being positioned on the downstream shoulder.
